(19) United States
(12) Patent Application Publication
(10) Pub. No.: US 2025/0203583 A1
(43) Pub. Date: Jun. 19, 2025

(54) METHODS FOR PDSCH ALLOCATIONS IN SBFD

(71) Applicant: MediaTek Singapore Pte. Ltd., Singapore (SG)

(72) Inventors: Jozsef Gabor NEMETH, Cambridge (GB); Mohammed S Aleabe AL-IMARI, Cambridge (GB)

(21) Appl. No.: 18/875,303

(22) PCT Filed: Jul. 12, 2023
(86) PCT No.: PCT/CN2023/106855

§ 371 Date: Dec. 16, 2024

Related U.S. Application Data
(60) Provisional application No. 63/371,239, filed on Aug. 12, 2022.

(51) Int. Cl. H04W 72/04

(52) U.S. Cl. CPC H04W 72/04

(57) ABSTRACT

Techniques pertaining to techniques for physical downlink shared channel (PDSCH) allocation in subband full duplex (SBFD) networks are described. Such techniques pertain to both PDSCH frequency domain resource allocation (FDRA) Type-0 and/or FDRA Type-1 and include the use of fractional resource block groups (RBGs), virtual resource block (VRB)-interleaving, canceling one or more repetitions or SPS transmission in a slot that is an SBFD slot or a non-SBFD slot. The techniques further include VRB-to-physical resource block (PRB) mapping that excludes one or more PRBs in the sequence of PRBs that belong to one or more UL-subband or one or more guard bands and applying one or more rules to provide for the selection of a wideband setting for a precoder resource block (RB) group (PRG) size with respect to use of a physical downlink shared channel (PDSCH) demodulation reference signal (DMRS).

### CROSS REFERENCE TO RELATED PATENT APPLICATION(S)

The present disclosure is part of a non-provisional application claiming the priority benefit of U.S. Patent Application No. 63/371,239, filed 12 Aug. 2022, the content of which herein being incorporated by reference in its entirety.

### TECHNICAL FIELD

The present disclosure is generally related to mobile communications and, more particularly, to techniques for user equipment (UE) configuration and scheduling in subband full duplex (SBFD) networks.

### BACKGROUND

Unless otherwise indicated herein, approaches described in this section are not prior art to the claims listed below and are not admitted as prior art by inclusion in this section.

In SBFD, all UEs operate in a half-duplex manner by either sending or receiving data transmissions at a particular time, whereas a base station node, e.g., a gNodeB (gNB), can concurrently transmit and receive data on non-overlapping subbands of a carrier. For example, a gNB may receive from UE #1 and UE #2 over uplink (UL) subbands while transmitting to UE #3 over one or more downlink (DL) subbands. A DL subband refers to a resource block (RB) or a set of contiguous RBs available for downlink in frequency-domain resource allocations. Similarly, a UL subband refers to an RB or a set of contiguous RBs available for uplink in frequency-domain resource allocations. Furthermore, a subband partition format is a configuration that specifies all the subbands over the DL or UL bandwidth part (BWP) bandwidth or over a UE channel bandwidth.

The partition of a slot or symbols into downlink and uplink subbands may be referred to as an SBFD partition format, and a periodic pattern of time-division duplexing (TDD) and SBFD configurations per slots/symbols may be referred to as an SBFD layout configuration. Since legacy UEs only support TDD configuration features, their transmission and reception are governed solely by scheduling and applied TDD configurations. On the other hand, a gNB may share knowledge about SBFD layout configurations with enhanced UEs. However, it is not possible to exclude the possibility that an SBFD partition is unknown to some UEs in some instances. Thus, how to enhance configuration and signaling that allows flexible PDSCH allocation in SBFD at a minimal cost to UE complexity remains a technical challenge. Therefore, there is a need for a solution of techniques for PDSCH allocation in SBFD networks.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions involving techniques for UE configuration and scheduling in SBFD networks.

In one aspect, a method may include identifying a particular RBG at an edge of a DL-subband that partially overlaps with a UL-subband or a GB of PRBs of a carrier in a PDSCH FDRA Type-0 allocation bitmap. The method may further include providing information on the particular RBG that partially overlaps with the UL-subband or the GB to a UE to direct the UE to use a non-overlapping fraction of the particular RBG that does not overlap with the UL-subband or the GB for PDSCH FDRA Type-0 transmission of data.

In another aspect, a method may include may selecting a sequence of PRBs of a carrier for PDSCH FDRA Type-1. The method may further include performing a VRB-to-PRB mapping that maps a plurality of PRBs in the sequence of PRBs to a sequence of VRBs, wherein the mapping excludes one or more PRBs in the sequence of PRBs that belong to one or more UL-subband or one or more guard bands.

In a further aspect, an apparatus implementable in a network may include a transceiver and a processor coupled to the transceiver. The transceiver may be configured to communicate wirelessly. The processor may be configured to determine that one or more of a set of conditions exists with respect to the use of PDSCH DMRS. The set of conditions including a wideband setting as a PRG size is only selectable with contiguous FDRA, and a rule-based dynamic selection of the wideband setting as the PRG size in a Bundle Size Set I setting is conditioned on an allocation size of the PRG meeting or exceeding half of a BWP bandwidth. The PRG size is a part of the PRB-Bundling Type setting of an RRC IE of the PDSCH DMRS, and the Bundle Size Set 1 setting is a DCI configuration setting for the PDSCH. Subsequently, in response to a determination that the one or more of the set of conditions exist, the processor may apply one or more rules to provide for the selection of the wideband setting for the PRG size.

It is noteworthy that, although the description provided herein may be in the context of certain radio access technologies, networks, and network topologies such as 5G/NR mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example scenario under a first proposed scheme in accordance with the present disclosure.

FIG. 3 is a diagram of an example scenario under a second proposed scheme in accordance with the present disclosure.

FIG. 4 is a diagram of an example scenario under a third proposed scheme in accordance with the present disclosure.

FIG. 5 is a diagram of an example scenario under a fourth proposed scheme in accordance with the present disclosure.

FIG. 6 is a block diagram of an example communication system in accordance with an implementation of the present disclosure.

FIG. 7 is a flowchart of a first example process in accordance with an implementation of the present disclosure.

FIG. 8 is a flowchart of a second example process in accordance with an implementation of the present disclosure.

FIG. 9 is a flowchart of a third example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to techniques for PDSCH allocation in SBFD networks. According to the present disclosure, a number of possible solutions may be implemented separately or jointly. That is, although these possible solutions may be described below separately, two or more of these possible solutions may be implemented in one combination or another.

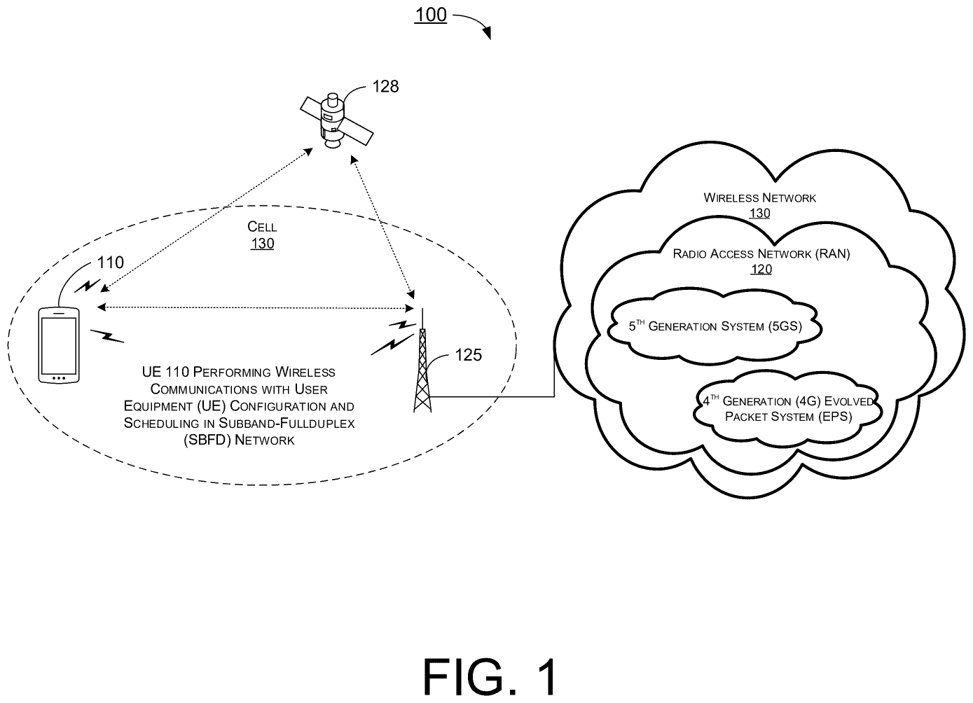

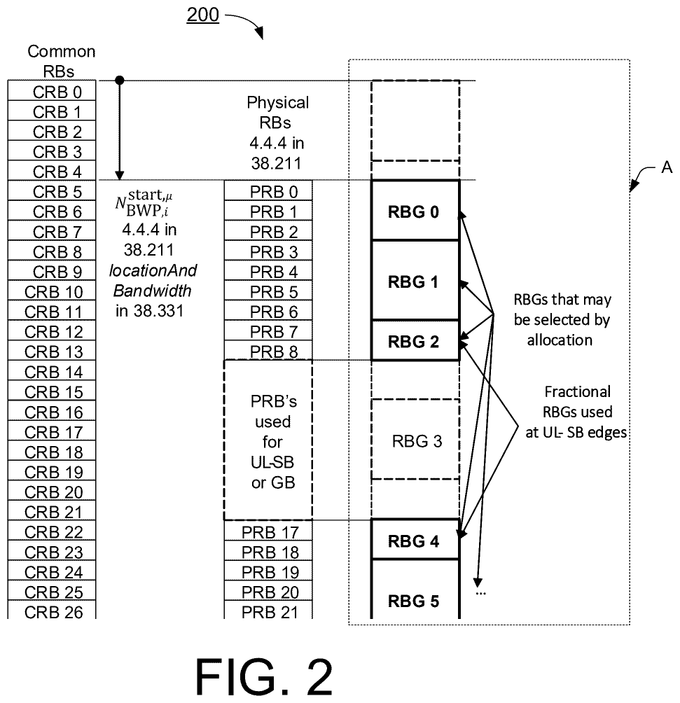

FIG. 1 illustrates an example network environment 100 in which various solutions and schemes in accordance with the present disclosure may be implemented. FIG. 2-FIG. 9 illustrate examples of implementation of various proposed schemes in network environment 100 in accordance with the present disclosure. The following description of various proposed schemes is provided with reference to FIG. 1-FIG. 9. For the purposes of the proposed schemes described in scenarios 200, 300, and 500, the working assumption is that if the SBFD partitioning is known to a UE for any symbol of the allocation, then the SBFD partitioning is the same for all symbols of the allocation, at least within the same slot. Thus, for a set of one or more symbols belonging to a DL or UL allocation, if a single SBFD partition is indicated (i.e., same for all symbols in the set) while for the rest of the symbols belonging to a DL or UL allocation the SBFD partition is unknown to the UE, then the UE may assign the same SBFD partition to these latter symbols. In one implementation, for an allocation with repetitions, each repetition instance is processed separately by the UE. However, in another implementation in which there is an allocation with repetitions, all repetition instances may be processed together by the UE and a single SBFD partition is allowed. On the other hand, if no SBFD partition is indicated to any of the symbol(s) belonging to a DL or UL allocation, then the UE may assume that none of the symbols are partitioned into subbands.

Referring to FIG. 1, network environment 100 may include a UE 110 in wireless communication with a RAN 120 (e.g., a 5G NR mobile network or another type of network such as an NTN). UE 110 may be in wireless communication with RAN 120 via a base station or network node 125 (e.g., an eNB, gNB, or transmit-receive point (TRP)). RAN 120 may be a part of a network 130. In network environment 100, UE 110 and network 130 (via network node 125 of RAN 120) may implement various schemes pertaining to techniques for UE configuration and scheduling in SBFD networks, as described below. It is noteworthy that, although various proposed schemes, options, and approaches may be described individually below, in actual applications these proposed schemes, options, and approaches may be implemented separately or jointly. That is, in some cases, each of one or more of the proposed schemes, options, and approaches may be implemented individually or separately. In other cases, some or all of the proposed schemes, options, and approaches may be implemented jointly.

FIG. 2 illustrates an example scenario 200 under a first proposed scheme in accordance with the present disclosure. Scenario 200 may pertain to physical downlink shared channel (PDSCH) allocation, which may be dynamically indicated through downlink control information (DCI) using Type-0 frequency domain resource allocation (FDRA). FDRA Type-0 is based on an allocation bitmap where each bit represents an RB group with RB size depending on a BWP-size and a binary configuration option that allows halving the bitmap size (e.g., max. 18 vs. max 9 bits) of resource block groups (RBGs)) at the expense of doubling the RBG size (e.g., a power of two between 2 and 16 RBs). Thus, Type-0 FDRA readily allows for flexible and non-contiguous RB allocations that assist in SBFD operation to allocate RBs from multiple non-contiguous DL subbands. However, a problem with the use of Type-0 FDRA is that resource fragmentation may occur at the edge(s) of DL subbands(s) near the UL-subband(s).

In one implementation, a UE may be configured to alleviate this problem by supporting Type-0 FDRA that comprises fractional RGBs at such boundaries based on the knowledge of partitioned symbols at the boundary between DL and UL subbands. As illustrated in Part (A) of the example shown in FIG. 2, a UE may be configured to support the use of fractional RBGs, e.g., fractions of RBGs 2 and 4, at the edges of DL subbands (UL-SBs) near the UL-subbands and/or guard bands (GBs) of the physical resource blocks (PRBs) of a carrier. This means that an RBG that partially overlaps with a UL-SB or a GB of the PRBs that is required to separate the DL-subbands and UL-subbands can also be allocated for the transmission of data. However, only the fraction of such an RGB that does not overlap with the UL-SB or the GB, i.e., the non-overlapping fraction of the RBG, is used for the transmission.

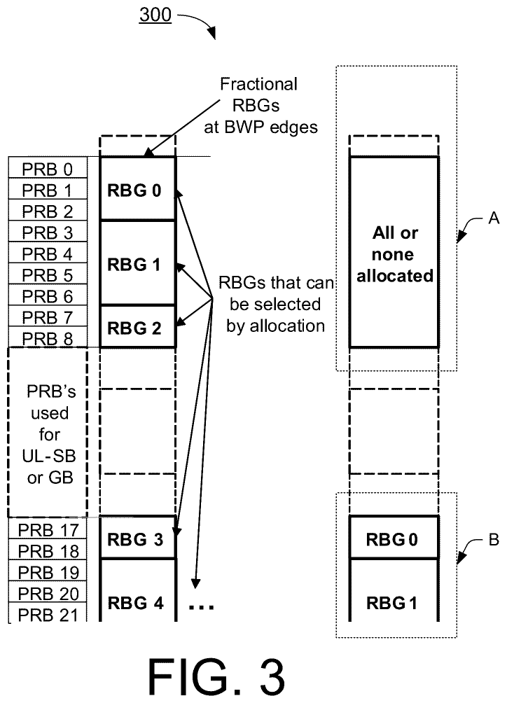

FIG. 3 illustrates an example scenario 300 under a second proposed scheme in accordance with the present disclosure. Scenario 300 may pertain to PDSCH FDRA Type-0, in which a tradeoff between allocation granularity vs. signaling overhead may be reconciled when full subbands are either used or not used by a multi-subband allocation. As illustrated in the example shown in FIG. 3, with Type-0 allocations over SBFD slots/symbols (i.e., partitioned between DL and UL), one part of an allocation bitmap (Part A) may be used to signal allocation by subband whereas the other part (Part B) of the allocation bitmap may be used to signal allocation by RBG. Such an allocation map may include one or more features. For example, a first feature may be that the FDRA allocation bitmap size as defined by a higher layer definition of the PDSCH FDRA Type-0 may be retained. A second feature may be that the allocation map excludes RBGs that fully overlap with a UL subband or a guard band.

A third feature may be that reserve flags may be in the bitmap for indication of which DL-subband(s) is/are used for allocation fully or at least partially. Accordingly, the remaining bits in the allocation bitmap may indicate allocation of corresponding RBGs within the set of RBGs that belong to DL-subslots, which are at least allocated partially. A fourth feature may be that if the available bitmap length allows, the size of each RBG may be divided by two, except when the size of the RBG 20 is already two. A fifth feature may be that the allocation bitmap is padded with zeros, ones, and/or undefined bits.

A sixth feature may be that in a case with M DL-subbands (in which M is an integer), each of the first M bits in the bitmap may indicate if the respective bit is fully allocated (when bit is set to 1) or at most partially allocated. For example, If the BWP BW and rbg_size configurations yield a 9 bits bitmap according to Release 17 (R17) of the 3GPP specification, and out of two subbands the first one is fully allocated, then in configuration ‘10|1111000’, the ‘10’ indicates allocation of the full first subband, and the ‘1111000’ indicates allocation of the first four RBGs of the second DL-subband. A seventh feature may be that in a case with M DL-subbands (in which M is an integer), each of the first M−1 bits in the bitmap may indicate if the respective bit is fully allocated (when bit is set to 1) or at most partially allocated.

An eighth feature may be that in an implementation with two DL-subbands, two bits p are reserved to indicate one of the following allocation options: (1) Val_11—both sub-bands are at least partially allocated, and the remaining bits q in the bitmap <p|q> cover RBGs belonging to these two subbands; (2) Val_01-none of the RBGs of the first subband is used, and the remaining bits in the bitmap cover RBGs belonging to the second subband; and (3) Val_10-none of the RBGs of the second subband is used, and the remaining bits in the bitmap cover RBGs belonging to the first subband.

A ninth feature may be that in an implementation with two DL-subbands, two bits p are reserved to indicate one of the following allocation options: (1) Val_00—both sub-bands are at least partially allocated, and the remaining bits q in the bitmap <p|y> cover RBGs belonging to these two subbands; (2) Val_10—all of the RBGs of the first subband are used, and the remaining bits in the bitmap cover RBGs belonging to the second subband; and (3) Val_01—all of the RBGs of the second subband are used, and the remaining bits in the bitmap cover RBGs belongs to the first subband.

A tenth feature may be that in an implementation with two DL-subbands, two bits p are reserved to indicate one of the following allocation options: (1) Val_00—both sub-bands are at least partially allocated, and the remaining bits q in the bitmap <p|q> cover RBGs belonging to these two subbands; (2) Val_01-none of the RBGs of the first subband are used, and the remaining bits in the bitmap cover RBGs belonging to the second subband; (3) Val_10-none of the RBGs of the second subband is used, and the remaining bits in the bitmap cover RBGs belonging to the first subband; and (4) Val_11—all of the RBGs of the first subband are used, the remaining bits in the bitmap cover RBGs belonging to the second subband.

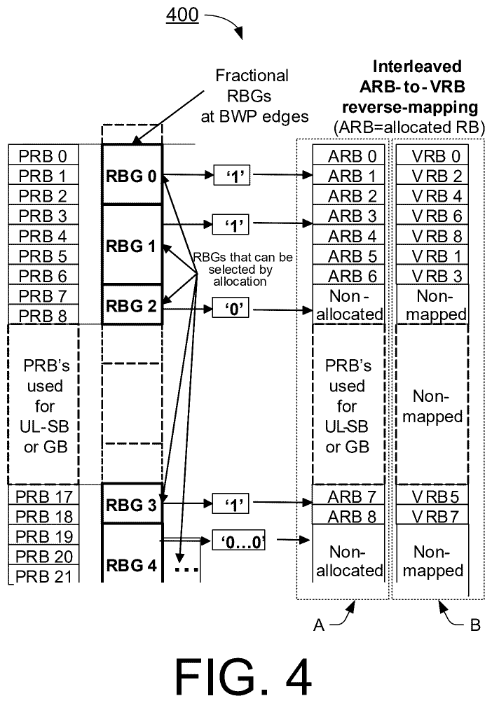

FIG. 4 illustrates an example scenario 400 under a third proposed scheme in accordance with the present disclosure. Scenario 400 may pertain to code block group (CBG)-based PDSCH allocation, in which virtual resource block (VRB)-interleaving is used with FDRA Type-0. Currently, VRB-interleaving is not available with FDRA Type-0, and VRB-interleaving with Type-1 is generally not compatible with SBFD. However, the example shown in FIG. 4 illustrates that VRB-interleaving with FDRA Type-0 may be achieved using one or more features. A first feature is that an existing VRB-interleaving field of the DCI for the PDSCH may be used for signaling the VRB-interleaving for FDRA Type-0. A second feature is that enabling and disabling VRB-interleaving does not change the set of allocated PRBs. The third feature is that when VRB-interleaving is enabled, even VRB indices are mapped first to the allocated PRB sequence starting from the allocated PRB with a lowest index, then the odd VRB indices are mapped to the remaining allocated PRBs. Thus, in the example shown in FIG. 4, Part (A) illustrated the sequence of PRBs of a carrier that are allocated for use from an original sequence of PRBs of a carrier, in which the allocated PRBs are referred to as allocated PRBs (ARBs). Part (B) shows the sequence VRBs that are interleaved with the ARBs via an ARB-to-VRB reverse mapping using the one or more features. As shown, VRBs in the sequence of VRBs (Part B) with even VRB indices are initially mapped to the sequence of ARBs (Part A) sequentially starting from an ARB in the sequence of ARBs with a lowest index until all VRBs with even VRB indices are mapped. Subsequently, VRBs in the sequence of VRBs (Part B) with odd VRB indices are sequentially mapped to the remaining ARBs in the sequence of ARBs (Part A).

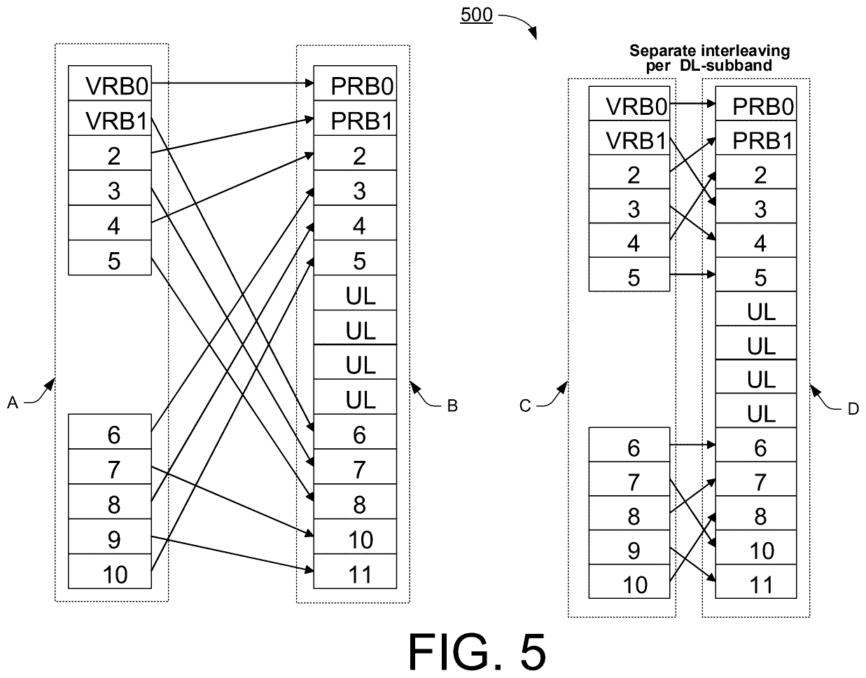

FIG. 5 illustrates an example scenario 500 under a fourth proposed scheme in accordance with the present disclosure. Scenario 500 may pertain to an enhancement that is made to PDSCH FDRA Type-1 over non-contiguous PRBs. Generally speaking, FDRA Type-1 provides fully flexible start RB and RB length over a contiguous set of PRBs. Additionally, FDRA Type-1 enables interleaved allocation over two contiguous sets of PRBs at half the BWP BW distance. Thus, because FDRA Type-1 is based on starting RB and RB length, FDRA Type-1 supports RB granularity allocations but only over a contiguous segment of VRBs. Contrary to Type-0 FDRA where each VRB always maps to the PRB having the same index, in FDRA Type-1 VRB-interleaving can be signaled dynamically, whereby the allocated VRB segment is mapped to two PRB segments starting at half the active BWP bandwidth distance, such that even PRBs are mapped to the lower segment and odd PRBs to the higher segment. Furthermore, only FDRA Type-I can be used with DCI 1_0 and during initial access. As a result, FDRA Type-1 is generally not suitable for simultaneous allocations over two (or more) DL subbands.

However, there are several solutions for overcoming this problem. One solution is a VRB-to-PRB mapping that excludes PRBs that belong to UL-subbands or guard bands for FDRA Type-1. Such a mapping may be implemented using one or more techniques. In one technique, a first roundup (Log 2 M) bits may be used to select between subbands, and the remaining roundup (log 2 (N*(N+1)/2)) bits, where N is the width of the largest DL subband, are encoded as the start and length indicator (SLIV).

In another technique in which a single contiguous VRB range is indicated by existing SLIV rules, PRBs may be reindexed for the mapping by leaving out PRBs unavailable to downlink transmissions based on the SBFD configuration indicated to the UE. As shown in a first example illustrated in FIG. 5, in which Part (A) shows the VRBs and Part (B) shows the PRBs, VRB-interleaving may be enabled for this technique. However, in one alternative implementation, the VRB-interleaving may be disabled. Further, in another alternative implementation, the VRB-interleaving may be always disabled.

Another solution for overcoming the problem is that when VRB-interleaving is enabled for FDRA Type-1, the VRB-interleaving may be performed separately for each contiguous PRB segment to exclude PRBs that belong to UL-subbands or guard bands. This form of interleaving is shown by the interleaving of VBRs in Part (C) to PRBS in Part (D) of the second example illustrated in FIG. 5, in which a first VRB-interleaving is performed for PRBs with indices 0-5, and a second VRB-interleaving is performed for PRBs with indices 6-10. Such interleaving may be implemented using one or more techniques. In one technique, for each contiguous PRB segment, indices 0 . . . . Kᵢ−1 may be first applied to allocate the VRBs and PRBs according to RB size Kᵢ of i^{th} subband. Subsequently, the VRB-interleaving may be applied to each contiguous PRB segment by replacing the BW size by Kᵢ. In another technique, higher layer configurations of the PDSCH FDRA Type-1 may be used to determine where the RB range 0 . . . . Kᵢ−1 starts and ends for each subband for defining the VRB interleaving.

For both FDRA Type-0 and FDRA Type-1, when PDSCH is scheduled with repetitions, the same FDRA allocation information may need to be interpreted over a mix of SBFD and non-SBFD slots. Thus, several techniques may be implemented under a fifth proposed scheme in accordance with the present disclosure to define when a repetition is canceled in a slot, such as an SBFD slot or a non-SBFD slot. In a first technique, when PDSCH is scheduled with repetitions, repetitions are canceled in each slot where the SBFD partition does not match that of the first slot in a sequence of SBFD and non-SBFD slots.

In a second technique, when PDSCH is scheduled with repetitions, the FDRA behavior of the UE is adapted to the SBFD partition format of the first repetition instance. Further, all subsequent repetitions may use the same PRBs if all resource elements (REs) are available to the downlink, otherwise, the repetition instance is canceled for the slot.

In a third technique, when PDSCH is scheduled with repetitions, the FDRA behavior of the UE may be adapted to the SBFD partition format applicable to each repetition instance. In one example with FDRA Type-0 allocations over SBFD slots/symbols, RBG(s) partially overlapping with UL-SB and/or any guard band required to separate DL-subbands and UL-subbands may be allocated for transmission, such that the transmission uses the non-overlapping RBs only. This corresponds to the use of fractional RBGs described with respect to FIG. 2.

In another example with FDRA Type-0 allocations over SBFD slots/symbols, the adaptation may include using one part of the allocation bitmap for signal allocation by subband and using the other part of the bitmap for signal allocation by RBG as described with respect to FIG. 3. In an additional example with FDRA Type-0 allocations over SBFD slots/symbols, VRB-interleaving as discussed with respect to FIG. 4 may be used. In a further example with FDRA Type-1 allocations over SBFD slots/symbols, VRB-to-PRB mapping that excludes PRBs that belong to UL-subbands or guard bands, as described with respect to FIG. 5, may be used. Alternatively, when interleaving is enabled for FDRA Type-1, the interleaving may be performed per contiguous PRB segments separately, as further described with respect to FIG. 5, to deal with the repetitions.

FDRA for semi-persistent scheduling (SPS) may be determined based on enabling DCI in both FDRA Type-0 and FDRA Type-1. This means that when SPS allocations are scheduled, the same FDRA allocation information may need to be interpreted over a mix of SBFD and non-SBFD slots. Thus, several techniques may be implemented under a sixth proposed scheme in accordance with the present disclosure to define when SPS transmission is canceled in a slot. In a first technique, when SPS PDSCH is scheduled, the SPS transmission may be canceled in each slot when the SBFD partition does not match that of the first transmission in the sequence.

In a second technique, when SPS PDSCH is scheduled, the FDRA behavior of the UE is adapted to the SBFD partition format of the first SPS transmission based on enabling DCI. Further, all subsequent SPS transmissions may use the same PRBs if all REs are available to downlink, otherwise the SPS transmission is canceled for the slot.

In a third technique, when SPS PDSCH is scheduled, the FDRA behavior of the UE may be adapted to the SBFD partition format applicable to each SPS transmission. In one example with FDRA Type-0 allocations over SBFD slots/symbols, RBG(s) partially overlapping with UL-SB and/or any guard band required to separate DL-subbands and UL-subbands may be allocated for transmission, such that the transmission uses the non-overlapping RBs only. This corresponds to the use of fractional RBGs described with respect to FIG. 2.

In another example with FDRA Type-0 allocations over SBFD slots/symbols, the adaptation may include using one part of the allocation bitmap for signal allocation by subband and using the other part of the bitmap for signal allocation by RBG as described with respect to FIG. 3. In an additional example with FDRA Type-0 allocations over SBFD slots/symbols, VRB-interleaving as discussed with respect to FIG. 4 may be used. In a further example with FDRA Type-1 allocations over SBFD slots/symbols, VRB-to-PRB mapping that excludes PRBs that belong to UL-subbands or guard bands, as described with respect to FIG. 5, may be used. Alternatively, when interleaving is enabled for FDRA Type-1, the interleaving may be performed per contiguous PRB segments separately, as further described with respect to FIG. 5, to deal with the SPS allocations.

PDSCH demodulation reference signal (DMRS) is a special type of physical layer signal that functions as a reference signal for decoding PDSCH. In various aspects, DMRS mapping is based on a common resource block (CRB) index and then CRBs selected by PDSCH transmission bandwidth (BW). In the PRB-BundlingType setting of a radio resource control (RRC) information element (IE) of the DMRS, the Precoder RB Group (PRG) size may be in the range of {2 PRBs, 4 PRBs, ‘wideband’}, in which ‘wideband” is used for only certain situations, such as when a base station (BS) optimize the precoder using on reciprocity-based channel estimation. Further, ‘wideband” PRG can only be selected with contiguous FDRA. This may be an issue because ‘wideband’ PRG may have utility with allocation over non-contiguous DL-subbands in SBFD slots. Furthermore, rule-based dynamic selection of ‘wideband’ in Bundle Size Set 1 (a DCI configuration setting for PDSCH properties) is conditioned on allocation size of the PRG meeting or exceeding half of the BWP bandwidth. However, this ratio may be unreasonably high in certain scenarios of allocation over SBFD slot. For example, in some instances, the total available bandwidth in a DL-subband may be less than half of the BWP bandwidth.

However, these problems may be overcome with the use of one or more techniques under a seventh proposed scheme in accordance with the present disclosure. The first technique is that a ‘wideband’ PRG may be configured semi-statically when the allocation of the PRG is contiguous over the concatenated sequence of DL-subband RBs. However, a UE may only interpolate within the DL-subband in such a case. A second technique is that conditional PRG sizes such as ‘n2-wideband’ may be resolved such that ‘wideband’ is selected when (1) the allocation is contiguous over the concatenated sequence of DL-subband RBs; or (2) the size of the allocation achieves or exceeds a predetermined threshold. For example, the predetermined threshold may be half the BWP BW, a sum of all RBs in the DL BWP, half of DL-subband bandwidth (assuming that the allocation is confined within a single subband), or bandwidth of a full DL-subband (not precluding that the transmission stretches over multiple subbands).

A third technique is configuring the rule-based dynamic selection of ‘wideband’ in Bundle Size Set I to be conditioned on the allocation size achieving or exceeding any one of the following options, which may be fixed or selected by a predefined rule or configuration: (1) half the BWP BW; (2) a sum of all RBs in the DL BWP; (3) half of DL-subband bandwidth (assuming that the allocation is confined within a single subband); or (4) bandwidth of a full DL-subband (not precluding that the transmission stretches over multiple subbands). In a fourth technique, in the case of PDSCH being scheduled with repetitions or SPS, a slot yielding the lowest threshold may be used to determine a selection of a precoder and the same precoder is then used throughout the repetitions.

### Illustrative Implementations

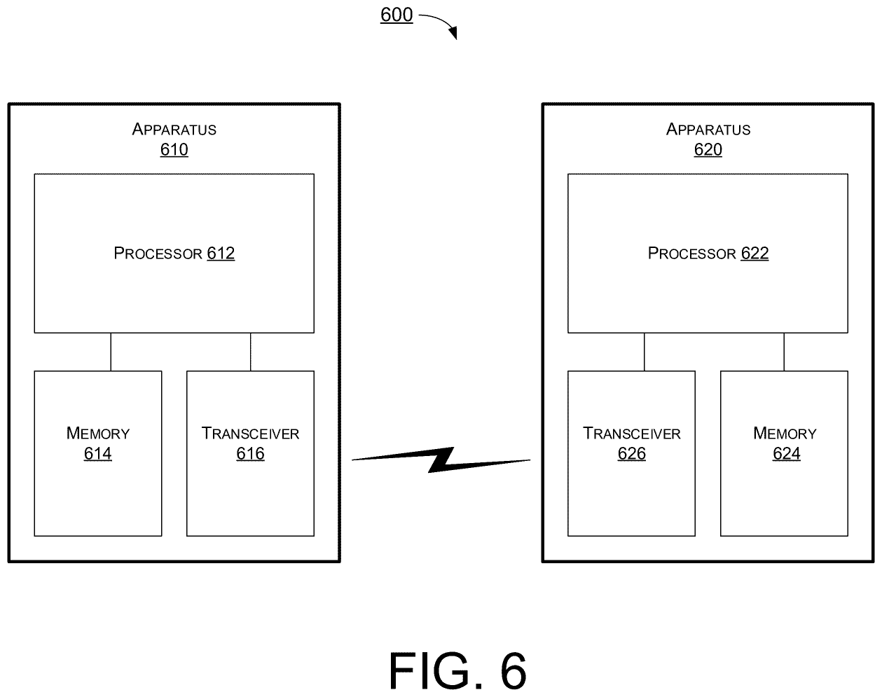

FIG. 6 illustrates an example communication system 600 having at least an example apparatus 610 and an example apparatus 620 in accordance with an implementation of the present disclosure. Each of apparatus 610 and apparatus 620 may perform various functions to implement schemes, techniques, processes and methods described herein pertaining to techniques for UE configuration and scheduling in SBFD networks, including the various schemes described above with respect to various proposed designs, concepts, schemes, systems and methods described above, including network environment 100, as well as processes described below.

Each of apparatus 610 and apparatus 620 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 610 and apparatus 620 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 610 and apparatus 620 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 610 and apparatus 620 may be implemented in a smart thermostat, a smart fridge, a smart door lock, a wireless speaker or a home control center. When implemented in or as a network apparatus, apparatus 610 and/or apparatus 620 may be implemented in an eNodeB in an LTE,

LTE-Advanced or LTE-Advanced Pro network or in a gNB or TRP in a 5G network, an NR network or an IoT network.

In some implementations, each of apparatus 610 and apparatus 620 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 610 and apparatus 620 may be implemented in or as a network apparatus or a UE. Each of apparatus 610 and apparatus 620 may include at least some of those components shown in FIG. 6 such as a processor 612 and a processor 622, respectively, for example. Each of apparatus 610 and apparatus 620 may further include one or more other components not pertinent to the proposed scheme of the present disclosure (e.g., internal power supply, display device and/or user interface device), and, thus, such component(s) of apparatus 610 and apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC or RISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including those pertaining to techniques for UE configuration and scheduling in SBFD networks in accordance with various implementations of the present disclosure.

In some implementations, apparatus 610 may also include a transceiver 616 coupled to processor 612. Transceiver 616 may be capable of wirelessly transmitting and receiving data. In some implementations, transceiver 616 may be capable of wirelessly communicating with different types of wireless networks of different radio access technologies (RATs). In some implementations, transceiver 616 may be equipped with a plurality of antenna ports (not shown) such as, for example, four antenna ports. That is, transceiver 616 may be equipped with multiple transmit antennas and multiple receive antennas for multiple-input multiple-output (MIMO) wireless communications. In some implementations, apparatus 620 may also include a transceiver 626 coupled to processor 622.

Transceiver 626 may include a transceiver capable of wirelessly transmitting and receiving data. In some implementations, transceiver 626 may be capable of wirelessly communicating with different types of UEs/wireless networks of different RATs. In some implementations, transceiver 626 may be equipped with a plurality of antenna ports (not shown) such as, for example, four antenna ports. That is, transceiver 626 may be equipped with multiple transmit antennas and multiple receive antennas for MIMO wireless communications.

In some implementations, apparatus 610 may further include a memory 614 coupled to processor 612 and capable of being accessed by processor 612 and storing data therein. In some implementations, apparatus 620 may further include a memory 624 coupled to processor 622 and capable of being accessed by processor 622 and storing data therein. Each of memory 614 and memory 624 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 614 and memory 624 may include a type of read-only memory (ROM) such as mask ROM, programmable ROM (PROM), erasable programmable ROM (EPROM) and/or electrically erasable programmable ROM (EEPROM). Alternatively, or additionally, each of memory 614 and memory 624 may include a type of non-volatile random-access memory (NVRAM) such as flash memory, solid-state memory, ferroelectric RAM (FeRAM), magnetoresistive RAM (MRAM) and/or phase-change memory.

Each of apparatus 610 and apparatus 620 may be a communication entity capable of communicating with each other using various proposed schemes in accordance with the present disclosure. For illustrative purposes and without limitation, a description of capabilities of apparatus 610, as a UE (e.g., UE 110), and apparatus 620, as a network node (e.g., network node 126 or another network node implementing one or more network-side functionalities described above) of an application server side network (e.g., network 130 as a 5G/NR mobile network), is provided below.

In some proposed schemes in accordance with the present disclosure pertaining to techniques for PDSCH allocation in SBFD networks, processor 622 of apparatus 620, implemented in or as a network node (e.g., UE 125) may identify a particular RBG at an edge of a DL-subband that partially overlaps with an UL-subband or a GB of PRBs of a carrier in a PDSCH FDRA Type-0 allocation bitmap. Subsequently, the processor 622 may provide information on the particular RBG that partially overlaps with the UL-subband or the GB to a UE via the transceiver 626 to direct the UE to use a non-overlapping fraction of the particular RBG that does not overlap with the UL-subband or the GB for PDSCH FDRA Type-0 transmission of data. For example, the information may be received by the UE via the transceiver 616 and processed by the processor 612.

In some implementations, the processor 622 may further allocate multiple PRBs from a sequence of PRBs of a carrier to generate a sequence of ARBs for use via the PDSCH FDRA Type-0, and then map the sequence of ARBs to VRBs via VRB-interleaving, the VRB-interleaving includes mapping a first set of VRBs in a sequence of VRBs with even VRB indices to the sequence of ARBs sequentially starting from an ARB with a lowest index, and then sequentially map a second set of VRBs in the sequence of VRBs with odd indices to remaining ARBs in the sequence of ARBs.

In some implementations in which the PDSCH is scheduled with repetitions, the processor 622 may cancel one or more repetitions in a slot that is an SBFD slot or a non-SBFD slot, the cancelation of the one or more repetitions may include: (1) canceling the one or more repetitions in the slot when an SBFD partition does not match that of a first slot in a sequence of SBFD and non-SBFD slots; (2) adapting an FDRA behavior of the UE to an SBFD partition format of a first repetition in the slot, and cancel a repetition for the slot when all REs are available to downlink but not all subsequent repetitions use identical PRBs; or (3) adapting an FDRA behavior of the UE to an SBFD partition format applicable to each repetition in the slot.

In some implementations in which SPS allocations are scheduled for the PDSCH, the processor 622 may cancel SPS transmission for a slot that is a SBFD slot or a non-SBFD slot, in which the cancelation of the SPS transmission may include: (1) canceling the SPS transmission in a slot when the SBFD partition does not match that of a first transmission in the sequence of SBFD and non-SBFD slots; (2) adapting an FDRA behavior of the UE to a SBFD partition format of a first SPS transmission after enabling DCI, and cancel a repetition for the slot when all REs are available to downlink but not all subsequent SPS transmissions use identical PRBs; or (3) adapting an FDRA behavior of the UE to a SBFD partition format applicable to each SPS transmission in the slot.

In other proposed schemes in accordance with the present disclosure pertaining to techniques for PDSCH allocation, processor 622 of apparatus 620, implemented in or as a network node (e.g., UE 125) may select a sequence of PRBs of a carrier for a PDSCH FDRA Type-1. Subsequently, the processor 622 may perform a VRB-to-PRB mapping that maps a plurality of PRBs in the sequence of PRBs to a sequence of VRBs, wherein the mapping excludes one or more PRBs in the sequence of PRBs that belong to one or more UL-subband or one or more guard bands.

In some implementations, the performance of the VRB-PRB mapping includes using first roundup (Log 2 M) bits to select between subbands, and wherein remaining roundup (log 2 (N*(N+1)/2)) bits, in which N is a width of a largest DL subband, are encoded as a SLIV.

In some implementations in which a single contiguous VRB range is indicated by existing SLIV rules, the performance of the VRB-PRB mapping includes reindexing the sequence of PRBs for the VRB-PRB mapping by leaving out PRBs unavailable to downlink transmissions based on an SBFD configuration indicated to a UE.

In some implementations in which VBR-interleaving is enabled for the VRB-PRB mapping and the VRB-interleaving is performed separately for each contiguous PRB segment in the sequence of PRBs, the VRB-interleaving is performed for each contiguous PRB segment by at least first applying indices 0 . . . . Kᵢ−1 to allocate the VRBs and PRBs according to RB size Ki of i^{th} subband, and then applying the VRB-interleaving to each contiguous PRB segment by replacing a BW size by Kᵢ. Alternatively, the VRB-interleaving is performed for each contiguous PRB segment by at least using higher layer configurations of the PDSCH FDRA Type-1 to determine where an RB range 0 . . . , Kᵢ−1 starts and ends for each subband for defining the VRB interleaving.

In some implementations in which the PDSCH is scheduled with repetitions, the processor 622 may cancel one or more repetitions in a slot that is an SBFD slot or a non-SBFD slot, the cancellation of the one or more repetitions may include: (1) canceling the one or more repetitions in the slot when an SBFD partition does not match that of a first slot in a sequence of SBFD and non-SBFD slots; (2) adapting an FDRA behavior of the UE to an SBFD partition format of a first repetition in the slot, and canceling a repetition for the slot when all REs are available to downlink but not all subsequent repetitions use identical PRBs; or (3) adapting an FDRA behavior of the UE to an SBFD partition format applicable to each repetition in the slot.

In some implementations in which SPS allocations are scheduled for the PDSCH, the processor 622 may cancel SPS transmission for a slot that is an SBFD slot or a non-SBFD slot, the cancelation of the SPS transmission includes: (1) canceling the SPS transmission in a slot when the SBFD partition does not match that of a first transmission in the sequence of SBFD and non-SBFD slots; (2) adapting an FDRA behavior of the UE to an SBFD partition format of a first SPS transmission after enabling DCI, and canceling a repetition for the slot when all REs are available to downlink but not all subsequent SPS transmissions use identical PRBs; or (3) adapting an FDRA behavior of the UE to an SBFD partition format applicable to each SPS transmission in the slot.

In additional proposed schemes in accordance with the present disclosure pertaining to techniques for PDSCH allocation, processor 622 of apparatus 620, implemented in or as a network node (e.g., UE 125) may determine that one or more of a set of conditions exists with respect to use of PDSCH DMRS. The set of conditions including a wideband setting as a PRG size is only selectable with contiguous FDRA, and a rule-based dynamic selection of the wideband setting as the PRG size in a Bundle Size Set I setting is conditioned on an allocation size of the PRG meeting or exceeding half of a BWP bandwidth. The PRG size is a part of the PRB-BundlingType setting of an RRC IE of the PDSCH DMRS, and the Bundle Size Set I setting is a DCI configuration setting for the PDSCH. Subsequently, in response to a determination that the one or more of the set of conditions exist, the processor 622 may apply one or more rules to provide for the selection of the wideband setting for the PRG size.

In some implementations, the application the one or more rules includes the processor 622 perform at least one of: (A) providing for the wideband setting for the PRG size to be configured semi-statically when an allocation of a wideband PRG is contiguous over a concatenated sequence of downlink (DL)-subband RBs; (B) configuring the wideband setting to be selected for the PRG size when the allocation of the wideband PRG is contiguous over a concatenated sequence of DL-subband RBs or when a size of the allocation of the wideband PRG meets or exceeds one of: (1) half of the BWP bandwidth; (2) a sum of all RBs in a DL BWP; (3) half of a DL-subband width when the allocation of the wideband PRG is confined with a single subband; or (4) a bandwidth of a full DL-subband; (C) providing for a dynamic selection of the wideband setting in Bundle Size set 1 conditioned on the size of the allocation of the wideband PRG meeting or exceeding one of: (1) the half of the BWP bandwidth; (2) the sum of all RBs in the DL BWP; (3) the half of the DL-subband width when the allocation of the wideband PRG is confined with the single subband; or (4) the bandwidth of the full DL-subband; and (D) for PDSCH scheduled with repetitions or SPS, using a slot that yields a lowest threshold to determine the precoder selection and using the precoder through the repetitions. It will be appreciated that when the wideband setting for the PRG size is configured semi-statically, a UE is configured to only interpolate within a subband.

### Illustrative Processes

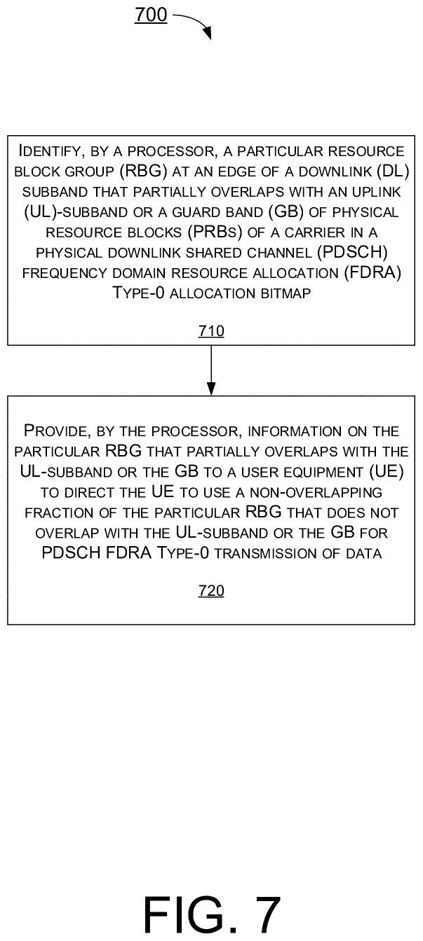

FIGS. 7-9 illustrates an example process 700-900 in accordance with an implementation of the present disclosure. Each of the processes 700-900 may represent an aspect of implementing various proposed designs, concepts, schemes, systems, and methods described above, whether partially or entirely, including those pertaining to those described above. More specifically, process 600 may represent an aspect of the proposed concepts and schemes pertaining to techniques for UE configuration and scheduling in SBFD networks. Each of the processes 700-900 may include one or more operations, actions, or functions as illustrated by one or more blocks. Although illustrated as discrete blocks, various blocks of each process may be divided into additional blocks, combined into fewer blocks, or eliminated, depending on the desired implementation. Moreover, the blocks/sub-blocks of each process may be executed in the order shown in each figure or, alternatively in a different order. Furthermore, one or more of the blocks/sub-blocks of each process may be executed iteratively. Each of the processes 700-900 may be implemented by or in apparatus 610 and apparatus 620 as well as any variations thereof. Solely for illustrative purposes and without limiting the scope, process 600 is described below in the context of apparatus 610 as a UE (e.g., UE 110) and apparatus 620 as a communication entity such as a network node or base station (e.g., network node 125 or another network node implementing one or more network-side functionalities described above) of an application server side network (e.g., network 130).

FIG. 7 is a flowchart of an example process 700 in accordance with an implementation of the present disclosure. At 710, process 700 may include processor 622 of the apparatus 620, implemented in or as a network node (e.g., UE 125), identifying a particular RBG at an edge of a DL-subband that partially overlaps with an UL-subband or a GB of PRBs of a carrier in a PDSCH FDRA Type-0 allocation bitmap.

At 720, the process 700 may include the processor 622 providing information on the particular RBG that partially overlaps with the UL-subband or the GB to a UE to direct the UE to use a non-overlapping fraction of the particular RBG that does not overlap with the UL-subband or the GB for PDSCH FDRA Type-0 transmission of data.

In some implementations, the process 700 may include the processor 622 allocating multiple PRBs from a sequence of PRBs of a carrier to generate a sequence of ARBs for use via the PDSCH FDRA Type-0, and then mapping the sequence of ARBs to VRBs via VRB-interleaving, the VRB-interleaving includes mapping a first set of VRBs in a sequence of VRBs with even VRB indices to the sequence of ARBs sequentially starting from an ARB with a lowest index, and then sequentially mapping a second set of VRBs in the sequence of VRBs with odd indices to remaining ARBs in the sequence of ARBs.

In some implementations in which the PDSCH is scheduled with repetitions, the process 700 may include the processor 622 canceling one or more repetitions in a slot that is a SBFD slot or a non-SBFD slot, the canceling the one or more repetitions includes: (1) canceling the one or more repetitions in the slot when an SBFD partition does not match that of a first slot in a sequence of SBFD and non-SBFD slots; (2) adapting an FDRA behavior of the UE to an SBFD partition format of a first repetition in the slot, and canceling a repetition for the slot when all REs are available to downlink but not all subsequent repetitions use identical PRBs; or (3) adapting an FDRA behavior of the UE to an SBFD partition format applicable to each repetition in the slot.

In some implementations in which SPS allocations are scheduled for the PDSCH, the process 700 may include the processor 622 canceling SPS transmission for a slot that is an SBFD slot or a non-SBFD slot, the canceling of the SPS transmission includes: (1) canceling the SPS transmission in a slot when the SBFD partition does not match that of a first transmission in the sequence of SBFD and non-SBFD slots; (2) adapting an FDRA behavior of the UE to an SBFD partition format of a first SPS transmission after enabling DCI, and canceling a repetition for the slot when all REs are available to downlink but not all subsequent SPS transmissions use identical PRBs; or (3) adapting an FDRA behavior of the UE to an SBFD partition format applicable to each SPS transmission in the slot.

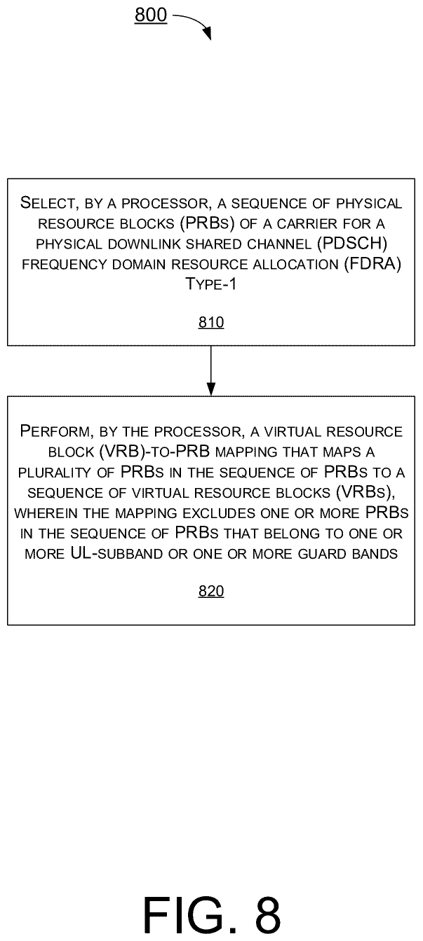

FIG. 8 is a flowchart of an example process 800 in accordance with an implementation of the present disclosure. At 810, process 800 may include processor 622 of the apparatus 620, implemented in or as a network node (e.g., UE 125), selecting a sequence of PRBs of a carrier for PDSCH FDRA Type-1.

At 820, the process 800 may include the processor 622 performing a VRB-to-PRB mapping that maps a plurality of PRBs in the sequence of PRBs to a sequence of VRBs, wherein the mapping excludes one or more PRBs in the sequence of PRBs that belong to one or more UL-subband or one or more guard bands.

In some implementations, the performance of the VRB-PRB mapping of the process 800 includes using first roundup (Log 2 M) bits to select between subbands, and wherein remaining roundup (log 2 (N*(N+1)/2)) bits, in which N is a width of a largest DL subband, are encoded as a SLIV.

In some implementations in which a single contiguous VRB range is indicated by existing SLIV rules, the performance of the VRB-PRB mapping of the process 800 includes reindexing the sequence of PRBs for the VRB-PRB mapping by leaving out PRBs unavailable to downlink transmissions based on an SBFD configuration indicated to a UE.

In some implementations in which VBR-interleaving is enabled for the VRB-PRB mapping and the VRB-interleaving is performed separately for each contiguous PRB segment in the sequence of PRBs, the VRB-interleaving is performed for each contiguous PRB segment by at least first applying indices 0 . . . . Kᵢ−1 to allocate the VRBs and PRBs according to RB size Ki of i^{th} subband, and then applying the VRB-interleaving to each contiguous PRB segment by replacing a BW size by Kᵢ. Alternatively, the VRB-interleaving is performed for each contiguous PRB segment by at least using higher layer configurations of the PDSCH FDRA Type-1 to determine where an RB range 0 . . . . Kᵢ−1 starts and ends for each subband for defining the VRB interleaving.

In some implementations in which the PDSCH is scheduled with repetitions, the process 800 may include the processor 622 canceling one or more repetitions in a slot that is an SBFD slot or a non-SBFD slot, the canceling the one or more repetitions includes: (1) canceling the one or more repetitions in the slot when an SBFD partition does not match that of a first slot in a sequence of SBFD and non-SBFD slots; (2) adapting an FDRA behavior of the UE to an SBFD partition format of a first repetition in the slot, and canceling a repetition for the slot when all REs are available to downlink but not all subsequent repetitions use identical PRBs; or (3) adapting an FDRA behavior of the UE to an SBFD partition format applicable to each repetition in the slot.

In some implementations in which SPS allocations are scheduled for the PDSCH, the process 800 may include the processor 622 canceling SPS transmission for a slot that is an SBFD slot or a non-SBFD slot, the canceling of the SPS transmission includes: (1) canceling the SPS transmission in a slot when the SBFD partition does not match that of a first transmission in the sequence of SBFD and non-SBFD slots; (2) adapting an FDRA behavior of the UE to an SBFD partition format of a first SPS transmission after enabling DCI, and canceling a repetition for the slot when all REs are available to downlink but not all subsequent SPS transmissions use identical PRBs; or (3) adapting an FDRA behavior of the UE to an SBFD partition format applicable to each SPS transmission in the slot.

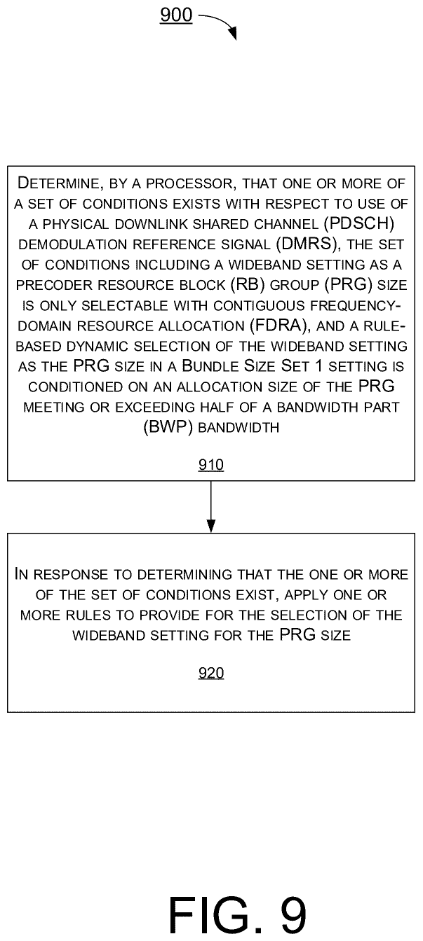

FIG. 9 is a flowchart of an example process 900 in accordance with an implementation of the present disclosure. At 910, process 900 may include processor 622 of the apparatus 620, implemented in or as a network node (e.g., UE 125), determining that one or more of a set of conditions exists with respect to the use of PDSCH DMRS. The set of conditions including a wideband setting as a PRG size is only selectable with contiguous FDRA, and a rule-based dynamic selection of the wideband setting as the PRG size in a Bundle Size Set I setting is conditioned on an allocation size of the PRG meeting or exceeding half of a BWP bandwidth. The PRG size is a part of the PRB-Bundling Type setting of an RRC IE of the PDSCH DMRS, and the Bundle Size Set 1 setting is a DCI configuration setting for the PDSCH.

At 920, the process 900 may include, in response to determining that the one or more of the set of conditions exist, the processor 622 may apply one or more rules to provide for the selection of the wideband setting for the PRG size.

In some implementations, applying the one or more rules includes the processor 622 perform at least one of: (A) providing for the wideband setting for the PRG size to be configured semi-statically when an allocation of a wideband PRG is contiguous over a concatenated sequence of downlink (DL)-subband RBs; (B) configuring the wideband setting to be selected for the PRG size when the allocation of the wideband PRG is contiguous over a concatenated sequence of DL-subband RBs or when a size of the allocation of the wideband PRG meets or exceeds one of: (1) half of the BWP bandwidth; (2) a sum of all RBs in a DL BWP; (3) half of a DL-subband width when the allocation of the wideband PRG is confined with a single subband; or (4) a bandwidth of a full DL-subband; (C) providing for a dynamic selection of the wideband setting in Bundle Size set 1 conditioned on the size of the allocation of the wideband PRG meeting or exceeding one of: (1) the half of the BWP bandwidth; (2) the sum of all RBs in the DL BWP; (3) the half of the DL-subband width when the allocation of the wideband PRG is confined with the single subband; or (4) the bandwidth of the full DL-subband; and (D) for PDSCH scheduled with repetitions or SPS, using a slot that yields a lowest threshold to determine the precoder selection and using the precoder through the repetitions. It will be appreciated that when the wideband setting for the PRG size is configured semi-statically, a UE is configured to only interpolate within a subband.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
identifying, by a processor of a network, a particular resource block group (RBG) at an edge of a downlink (DL)-subband that partially overlaps with an uplink (UL)-subband or a guard band (GB) of physical resource blocks (PRBs) of a carrier in a physical downlink shared channel (PDSCH) frequency domain resource allocation (FDRA) Type-0 allocation bitmap; and
providing, by the processor of the network, information on the particular RBG that partially overlaps with the UL-subband or the GB to a user equipment (UE) to direct the UE to use a non-overlapping fraction of the particular RBG that does not overlap with the UL-subband or the GB for PDSCH FDRA Type-0 transmission of data.

2. The method of claim 1, further comprising:
allocating, by the processor of the network, multiple physical resource blocks (PRBs) from a sequence of PRBs of a carrier to generate a sequence of allocated resource blocks (ARBs) for use via the PDSCH FDRA Type-0; and
mapping, by the processor of the network, the sequence of ARBs to virtual resource blocks (VRBs) via VRB-interleaving, the VRB-interleaving includes mapping a first set of VRBs in a sequence of VRBs with even VRB indices to the sequence of ARBs sequentially starting from an ARB with a lowest index, and then sequentially mapping a second set of VRBs in the sequence of VRBs with odd indices to remaining ARBs in the sequence of ARBs.

3. The method of claim 2, wherein enabling or disabling the VRB-interleaving does not change the sequence of ARBs.

4. The method of claim 2, wherein a VRB-interleaving field of downlink control information (DCI) for the PDSCH is used to signal the VRB-interleaving for the PDSCH FDRA Type-0.

5. The method of claim 1, wherein the PDSCH is scheduled with repetitions, further comprising canceling one or more repetitions in a slot that is a subband full duplex (SBFD) slot or a non-SBFD slot, the canceling the one or more repetitions includes:
canceling the one or more repetitions in the slot when an SBFD partition does not match that of a first slot in a sequence of SBFD and non-SBFD slots;
adapting an FDRA behavior of the UE to an SBFD partition format of a first repetition in the slot, and canceling a repetition for the slot when all REs are available to downlink but not all subsequent repetitions use identical PRBs; or
adapting an FDRA behavior of the UE to an SBFD partition format applicable to each repetition in the slot.

6. The method of claim 1, wherein semi-persistent scheduling (SPS) allocations are scheduled for the PDSCH, further comprising canceling SPS transmission for a slot that is a subband full duplex (SBFD) slot or a non-SBFD slot, the canceling of the SPS transmission includes:
canceling the SPS transmission in a slot when the SBFD partition does not match that of a first transmission in the sequence of SBFD and non-SBFD slots;
adapting an FDRA behavior of the UE to an SBFD partition format of a first SPS transmission after enabling DCI, and canceling a repetition for the slot when all REs are available to downlink but not all subsequent SPS transmissions use identical PRBs; or
adapting an FDRA behavior of the UE to an SBFD partition format applicable to each SPS transmission in the slot.

7. A method, comprising:
selecting, by a processor of a network, a sequence of physical resource blocks (PRBs) of a carrier for a physical downlink shared channel (PDSCH) frequency domain resource allocation (FDRA) Type-1; and
performing, by the processor of the network, a virtual resource block (VRB)-to-PRB mapping that maps a plurality of PRBs in the sequence of PRBs to a sequence of virtual resource blocks (VRBs), wherein the mapping excludes one or more PRBs in the sequence of PRBs that belong to one or more UL-subband or one or more guard bands.

8. The method of claim 7, wherein the performing the VRB-PRB mapping includes using first roundup (Log 2 M) bits to select between subbands, and wherein remaining roundup (log 2 (N*(N+1)/2)) bits, in which N is a width of a largest DL subband, are encoded as a start and length indicator (SLIV).

9. The method of claim 7, wherein a single contiguous VRB range is indicated by existing start and length indicator (SLIV) rules, and wherein the performing the VRB-PRB mapping includes reindexing the sequence of PRBs for the VRB-PRB mapping by leaving out PRBs unavailable to downlink transmissions based on a subband full duplex (SBFD) configuration indicated to a user equipment (UE).

10. The method of claim 7, wherein VBR-interleaving is enabled for the VRB-PRB mapping.

11. The method of claim 10, wherein the VRB-interleaving is performed separately for each contiguous PRB segment in the sequence of PRBs.

12. The method of claim 11, wherein the VRB-interleaving is performed for each contiguous PRB segment by at least first applying indices 0 . . . . Kᵢ−1 to allocate the VRBs and PRBs according to resource block (RB) size Ki of i^{th} subband, and then applying the VRB-interleaving to each contiguous PRB segment by replacing a BW size by Kᵢ.

13. The method of claim 11, wherein the VRB-interleaving is performed for each contiguous PRB segment by at least using higher layer configurations of the PDSCH FDRA Type-1 to determine where an RB range 0 . . . . Kᵢ−1 starts and ends for each subband for defining the VRB interleaving.

14. The method of claim 7, wherein VBR-interleaving is disabled for the VRB-PRB mapping.

15. The method of claim 7, wherein the PDSCH is scheduled with repetitions, further comprising canceling one or more repetitions in a slot that is a SBFD slot or a non-SBFD slot, the canceling the one or more repetitions includes:
canceling the or more repetitions in the slot when an SBFD partition does not match that of a first slot in a sequence of SBFD and non-SBFD slots;
adapting an FDRA behavior of the UE to an SBFD partition format of a first repetition in the slot, and canceling a repetition for the slot when all REs are available to downlink but not all subsequent repetitions use identical PRBs; or
adapting an FDRA behavior of the UE to an SBFD partition format applicable to each repetition in the slot.

16. The method of claim 7, wherein semi-persistent scheduling (SPS) allocations are scheduled for the PDSCH, further comprising canceling SPS transmission for a slot that is an SBFD slot or a non-SBFD slot, the canceling of the SPS transmission includes:
canceling the SPS transmission in a slot when the SBFD partition does not match that of a first transmission in the sequence of SBFD and non-SBFD slots;
adapting an FDRA behavior of the UE to an SBFD partition format of a first SPS transmission after enabling DCI, and canceling a repetition for the slot when all REs are available to downlink but not all subsequent SPS transmissions use identical PRBs; or
adapting an FDRA behavior of the UE to an SBFD partition format applicable to each SPS transmission in the slot.

17. An apparatus implementable in a network, comprising:
a transceiver configured to communicate with one or more network nodes of the network; and
a processor coupled to the transceiver and configured to perform operations comprising:
determining that one or more of a set of conditions exists with respect to use of a physical downlink shared channel (PDSCH) demodulation reference signal (DMRS), the set of conditions including a wideband setting as a precoder resource block (RB) group (PRG) size is only selectable with contiguous frequency-domain resource allocation (FDRA), and a rule-based dynamic selection of the wideband setting as the PRG size in a Bundle Size Set 1 setting is conditioned on an allocation size of the PRG meeting or exceeding half of a bandwidth part (BWP) bandwidth; and
in response to determining that the one or more of the set of conditions exist, applying one or more rules to provide for the selection of the wideband setting for the PRG size.

18. The apparatus of claim 17, wherein the applying the one or more rules performs at least one of:
providing for the wideband setting for the PRG size to be configured semi-statically when an allocation of a wideband PRG is contiguous over a concatenated sequence of downlink (DL)-subband RBs;
configuring the wideband setting to be selected for the PRG size when the allocation of the wideband PRG is contiguous over a concatenated sequence of DL-subband RBs or when a size of the allocation of the wideband PRG meets or exceeds one of: (1) half of the BWP bandwidth; (2) a sum of all RBs in a DL BWP; (3) half of a DL-subband width when the allocation of the wideband PRG is confined with a single subband; or (4) a bandwidth of a full DL-subband;
providing for a dynamic selection of the wideband setting in Bundle Size set 1 conditioned on the size of the allocation of the wideband PRG meeting or exceeding one of: (1) the half of the BWP bandwidth; (2) the sum of all RBs in the DL BWP; (3) the half of the DL-subband width when the allocation of the wideband PRG is confined with the single subband; or (4) the bandwidth of the full DL-subband; and
for PDSCH scheduled with repetitions or semi-persistent scheduling (SPS), using a slot that yields a lowest threshold to determine the precoder selection and using the precoder through the repetitions.

19. The apparatus of claim 18, wherein a user equipment (UE) is configured to only interpolate within a subband when the wideband setting for the PRG size is configured semi-statically.

20. The apparatus of claim 17, wherein the PRG size is a part of a PRB-BundlingType setting of a radio source control (RRC) information element (IE) of the PDSCH DMRS, and wherein the Bundle Size Set 1 setting is a DCI configuration setting for the PDSCH.
